(19) United States
(12) Patent Application Publication
(10) Pub. No.: US 2026/0067374 A1
(43) Pub. Date: Mar. 5, 2026

(54) SYSTEM AND METHODOLOGY THAT UTILIZES ARTIFICIAL INTELLIGENCE TO GENERATE DIGITAL PROFILES FROM DATA SOURCES

(71) Applicants: Leo Armando Ramirez, JR., Austin, TX (US); Ross Andrew Bagley, Woodinville, WA (US); Malissa Elliott White, Raleigh, NC (US)

(72) Inventors: Leo Armando Ramirez, JR., Austin, TX (US); Ross Andrew Bagley, Woodinville, WA (US); Malissa Elliott White, Raleigh, NC (US)

(21) Appl. No.: 19/315,322

(22) Filed: Aug. 29, 2025

Related U.S. Application Data
(60) Provisional application No. 63/689,557, filed on Aug. 30, 2024.

(51) Int. Cl. H04L 67/306

(52) U.S. Cl. CPC H04L 67/306

(57) ABSTRACT

Various aspects related to aggregating data associated with a person or entity and interpreting the data with an artificial intelligence tool are disclosed. In one such aspect, a method is provided, which includes creating a digital profile of the person or entity based on an interpretation of the data in which the digital profile includes at least one attribute associated with the person or entity. In another aspect, a method is provided, which includes categorizing the at least one attribute into at least one category. In a further aspect, another method is provided, which includes providing a suggestion to the person or entity in accordance with an inferred desired outcome in which the inferred desired outcome is an inference based on the at least one attribute associated with the person or entity within a context associated with the person or entity.

### TECHNICAL FIELD

This application claims the benefit of U.S. Provisional Patent Application Ser. No. 63/689,557, filed Aug. 30, 2024, which is titled “SYSTEM AND METHODOLOGY THAT UTILIZES ARTIFICIAL INTELLIGENCE TO GENERATE DIGITAL PROFILES FROM DATA SOURCES” and its entire contents of which are incorporated herein by reference.

### TECHNICAL FIELD

The subject disclosure generally relates to learning, and more specifically to a system and methodology that utilizes artificial intelligence to generate digital profiles from data sources.

### BACKGROUND

As digital technology becomes more ubiquitous, the aggregate amount of data collected when using such technology has grown significantly. With this growth, a more vivid picture of a person and/or entity is ascertainable from the digital footprint they leave behind. For instance, the types of food a person likes may be inferred from a digital log of their grocery purchases, whereas the type of music they like may be inferred from their usage of a music streaming application. Automating the collection and interpretation of such data is difficult, however, since data may reside in disparate locations and saved in any of various formats.

Accordingly, it would be desirable to provide a system and method which overcomes these limitations. To this end, it should be noted that the above-described deficiencies are merely intended to provide an overview of some of the problems of conventional systems, and are not intended to be exhaustive. Other problems with the state of the art and corresponding benefits of some of the various non-limiting embodiments may become further apparent upon review of the following detailed description.

### SUMMARY

A simplified summary is provided herein to help enable a basic or general understanding of various aspects of exemplary, non-limiting embodiments that follow in the more detailed description and the accompanying drawings. This summary is not intended, however, as an extensive or exhaustive overview. Instead, the sole purpose of this summary is to present some concepts related to some exemplary non-limiting embodiments in a simplified form as a prelude to the more detailed description of the various embodiments that follow.

In accordance with one or more embodiments and corresponding disclosure, various non-limiting aspects are described in connection with utilizing artificial intelligence to facilitate generating digital profiles from data sources. In one such aspect, a method is provided, which includes aggregating data associated with a person or entity and interpreting the data associated with the person or entity with an artificial intelligence tool. Within such embodiment, the artificial intelligence tool is configured to infer at least one attribute associated with the person or entity via an interpretation of the data. The method further includes creating a digital profile of the person or entity based on the interpretation of the data in which the digital profile includes the at least one attribute associated with the person or entity.

In a further aspect, another method is provided, which includes aggregating data associated with a person or entity in which the data includes a plurality of individual aspects associated with the person or entity. The method further includes interpreting the data associated with the person or entity with an artificial intelligence tool in which the artificial intelligence tool is configured to infer at least one attribute associated with the person or entity via an interpretation of at least one of the plurality of individual aspects associated with the person or entity. The method also includes categorizing the at least one attribute into at least one category.

In yet another aspect, another method is provided, which includes aggregating data associated with a person or entity in which the data includes a plurality of individual aspects associated with the person or entity. The method further includes interpreting the data associated with the person or entity with an artificial intelligence tool in which the artificial intelligence tool is configured to infer at least one attribute associated with the person or entity via an interpretation of at least one of the plurality of individual aspects associated with the person or entity. The method also includes providing a suggestion to the person or entity in accordance with an inferred desired outcome in which the inferred desired outcome is an inference based on the at least one attribute associated with the person or entity with a context associated with the person or entity.

Other embodiments and various non-limiting examples, scenarios and implementations are described in more detail below.

### BRIEF DESCRIPTION OF THE DRAWINGS

Various non-limiting embodiments are further described with reference to the accompanying drawings in which:

FIG. 1 illustrates an exemplary environment that facilitates generating digital profiles in accordance with an aspect of the subject specification;

FIG. 2 illustrates an exemplary digital profile in accordance with an aspect of the subject specification;

FIG. 3 is a block diagram illustrating an exemplary coupling of a software application to the management system disclosed herein in accordance with an aspect of the subject specification;

FIG. 4 illustrates a block diagram of an exemplary management system that facilitates implementing aspects disclosed herein;

FIG. 5 is a flow diagram of an exemplary profile generation methodology in accordance with an aspect of the subject specification;

FIG. 6 is a block diagram representing exemplary non-limiting networked environments in which various embodiments described herein can be implemented; and

FIG. 7 is a block diagram representing an exemplary non-limiting computing system or operating environment in which one or more aspects of various embodiments described herein can be implemented.

### DETAILED DESCRIPTION

### Overview

As discussed in the background, it is desirable to provide a system and method which overcomes the various limitations of interpreting data from disparate data sources. The embodiments disclosed herein are directed towards overcoming such limitations by providing a system and methodology that utilizes artificial intelligence (AI) to create digital profiles of a person or entity from data collected from disparate sources. For instance, in a particular embodiment, a centralized data management system is disclosed, wherein data collected from disparate sources is interpreted by an AI tool to facilitate the creation of dynamic digital profiles. Within such embodiment, it is contemplated that digital profiles are continuously updated as more data is collected and interpreted. Once created, it is further contemplated that digital profiles may be utilized in any of various ways including, but not limited to, matching a person or entity with other people or entities based on their respective digital profiles.

### Exemplary Embodiments

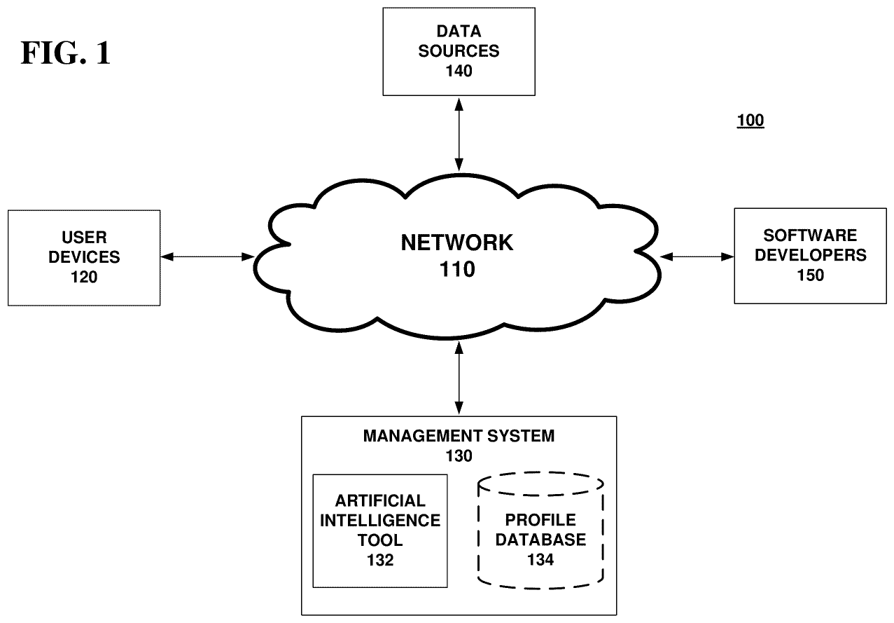

Turning now to FIG. 1, an exemplary environment that facilitates generating digital profiles according to an embodiment is provided. As illustrated, environment 100 includes a coupling of user devices 120, management system 130, data sources 140, and software developers 150 via network 110 (e.g., the Internet, a radio frequency identification (RFID) network, a Bluetooth network, etc.). In an aspect disclosed herein, it is contemplated that users utilizing user devices 120 (e.g., a smartphone, laptop, etc.) can create digital profiles via management system 130 from data stored in data sources 140.

The process of creating a digital profile may begin with a user granting management system 130 access to their data, which may be stored in any of various data sources 140. For instance, such data sources 140 may include financial institutions, social media applications, and any other data sources 140 where data associated with the user may reside. Management system 130 may then aggregate data associated with the user from data sources 140, which is then interpreted by artificial intelligence (AI) tool 132. Here, it is contemplated that AI tool 132 is configured to infer at least one attribute associated with the user via an interpretation of the data received from data sources 140. For instance, AI tool 132 may interpret a digital receipt retrieved from a retail institution as a baseball glove purchase, wherein AI tool 132 then infers that the user has an interest in baseball. Management system 130 then creates a digital profile of the user based on the interpretation of the data retrieved from data sources 140, wherein the digital profile is stored in profile database 134 and includes attributes of the user inferred by AI tool 132.

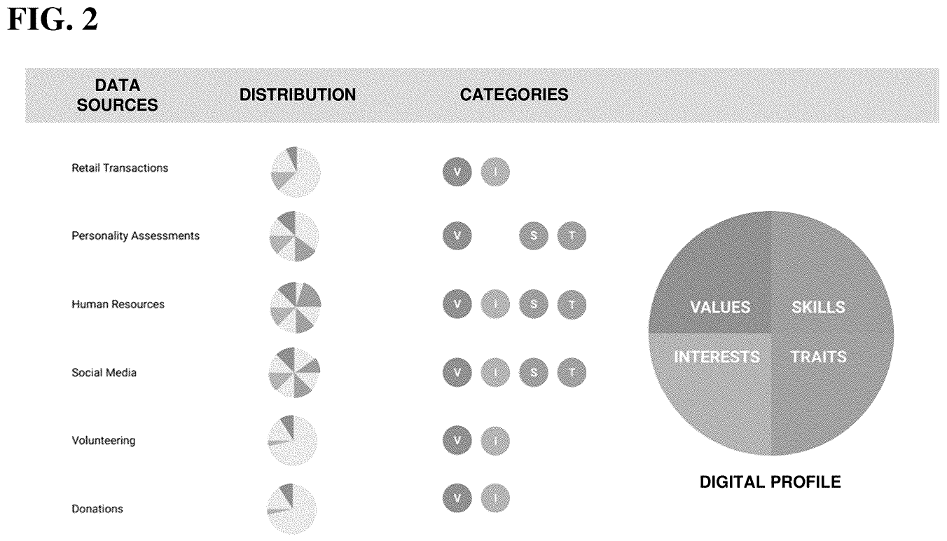

Referring next to FIG. 2, an exemplary digital profile is provided in accordance with an aspect of the subject specification. As illustrated, it is contemplated that a digital profile may be created from any of various types of data sources 140. For this particular example, a user's digital profile is based on data sources associated with retail transactions, personality assessments, human resources, social media, volunteering, and donations.

In an aspect disclosed herein, it should be appreciated that attributes inferred by AI tool 132 can be grouped into various categories. As shown, for this particular example, attributes are categorized as relating to a user's values, skills, interests, and/or traits. When categorizing inferred attributes, it is contemplated that AI tool 132 may weight inferences differently based on the data itself and/or the data source from where the data was retrieved. In FIG. 2, for instance, an exemplary categorization and weighting of attributes inferred from each data source is shown.

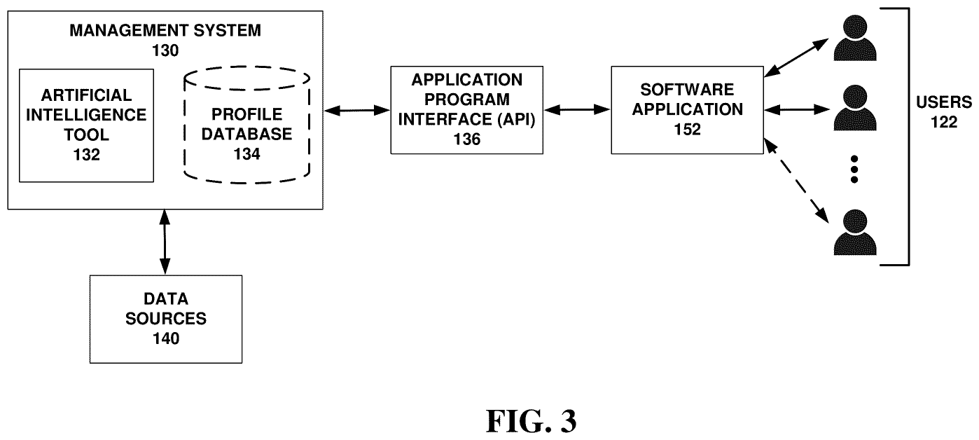

In another aspect disclosed herein, it is contemplated that digital profiles may be utilized in any of various ways including by third party applications created by software developers 150. Referring next to FIG. 3, a block diagram is provided illustrating an exemplary coupling of a software application to the management system disclosed herein in accordance with an aspect of the subject specification. As illustrated, it is contemplated that a software application 152 (e.g., created/hosted by software developers 150) used by users 122 (e.g., users who created digital profiles via user devices 120) interfaces with management system 130 via application program interface (API) 136.

Various exemplary use cases for the aspects disclosed herein are contemplated and listed below.

Aspect 1: A multi-source data aggregation system. This system and method involves compiling user data from various authorized sources (e.g., data sources 140), such as social media, financial transactions, human resources systems, blogs and forums, TV and movie-watching behaviors, and more. The data may aggregated into a unified data pool, which may reside in any of a plurality of locations (e.g., a user's personal device, cloud storage, etc.), wherein multiple, diverse sources feed into a personal data lake, resulting in a comprehensive, real-time profile of the user's behaviors and preferences.

Aspect 2: A real-time profiling system. This system and method leverages artificial intelligence (e.g., AI tool 132) to interpret the aggregated user data in real-time, dynamically generating a digital profile (e.g., various attributes categorized into at least one of Skills, Traits, Interests, and/or Values associated with the user). The system may be configured to continually adjust and update this profile as new data is ingested, ensuring that it always provides an accurate and up-to-date representation of the user.

Aspect 3: A customizable privacy control interface. It is contemplated that such interface may be configured to put users in control of their data via a user-friendly interface that allows users to choose which parts of their personal profile they share and with whom. The interface may be configured to be flexible and intuitive, giving users granular control over their privacy settings and fostering trust in the platform.

Aspect 4: An AI-driven personal matching system. Here, it is contemplated that AI may be used to compare individual and/or group profiles to identify potential matches between users, organizations, and brands. Such a mechanism goes beyond surface-level matching by incorporating nuanced aspects of the user's digital profile to find truly compatible matches.

Aspect 5: A system that generates context-sensitive AI-powered conversation prompts. It is contemplated that such system may generate relevant and personalized conversation prompts based on identified profile matches. The prompts are designed to facilitate meaningful conversations, easing initial introductions and aiding in the formation of authentic connections.

Aspect 6: A service personalization protocol. It is contemplated that such protocol may personalize external services based on a user's personal profile. Such protocol may thus enhance user experience and engagement by tailoring services to individual preferences and needs, making them feel valued and understood.

Aspect 7: An end-to-end encryption system for personal data. This system may provide top-level security for user data stored on personal devices, incorporating end-to-end encryption for all user interactions. Such a system would add an extra layer of protection for the user, ensuring that data remains secure from the moment it is collected until it is used or deleted.

Aspect 8: An audience selection system for profile sharing. This system may empower users to define specific audiences with whom they share their entire profiles with and others whom they only share parts of their profiles. Such a system provides flexibility in profile sharing and enhances privacy by allowing users to select who gets access to their personal profiles and to what extent.

Aspect 9: A system that performs dynamic audience matching based on personal data. This system may dynamically match users with specific audiences based on their personal profiles, location, and/or privacy settings. Such a system enables users to connect with like-minded individuals and/or organizations, fostering a sense of community and belonging.

Aspect 10: A retail personalization methodology. This methodology may use user profiles to personalize retail marketing strategies. By understanding a consumer's skills, traits, interests, and values, for example, retailers can tailor their marketing strategies, enhancing sales and customer loyalty.

Aspect 11: An influencer matching protocol. This protocol may use the categorization of attributes (e.g., into skills, traits, interests, and/or values) to match brands with influencers. By ensuring alignment between a brand and an influencer's values and interests, for example, the protocol may facilitate more effective and authentic influencer marketing campaigns.

Aspect 12: A workplace culture analysis system. This system may analyze the digital profiles of employees to foster a more inclusive and productive workplace culture. By understanding the varied skills, traits, interests, and values of its employees, for example, organizations can tailor their culture and policies to meet their employees'needs, driving higher satisfaction and productivity.

Aspect 13: A methodology for political affinity matching. It is contemplated that this methodology may leverage the ability of management system 130 to interpret data and infer personal attributes (e.g. attributes associated with a user's skills, traits, interests, and/or values) via AI tool 132, specifically within the context of political behavior and beliefs. For instance, management system 130 may be configured to match users with political candidates, parties, or causes that closely align with their digital profiles. Other aspects contemplated herein may include methodologies for re-evaluating and updating matches in real-time based on changing political landscapes.

Aspect 14: A methodology for political trend analysis and prediction. Here, it is contemplated that an extension of the AI-driven profiling aspects disclosed herein could include a predictive model for forecasting political trends. Based on the aggregation of user data and ongoing profile interpretation, methodologies are contemplated for anticipating shifts in political sentiment and voter behavior.

Aspect 15: A system for generating tailored political engagement recommendations. Such a system may be configured to generate personalized recommendations for political engagement based on a user's digital profile. Recommendations could include attending specific rallies, donating to particular causes, joining certain political organizations, and/or engaging in certain civic duties that align with the user's profile.

Aspect 16: A system for politicians to analyze feedback from their constituents. Such a system may be configured to leverage the ability of AI tool 132 to interpret feedback data and make corresponding inferences for politicians and/or political campaigns. For example, such system may analyze user feedback within the context of the user's digital profile to provide insights that help politicians better understand their constituents and adjust their strategies accordingly.

Aspect 17: A system for audience segmentation and outreach for politicians. Such a system may facilitate segmenting a politician's constituent or potential constituent base into specific audiences based on their digital profiles, and generate tailored outreach strategies for each segment.

It should be appreciated that various aspects disclosed herein contemplate configuring AI tool 132 to create digital profiles via generative AI. As used herein, it should be appreciated that generative AI broadly refers to a subset of AI systems designed to produce new, original content. Such systems may utilize advanced algorithms and deep learning techniques to learn patterns from extensive datasets and generate novel outputs that are often indistinguishable from human-created content. Core methods in generative AI include Generative Adversarial Networks (GANs) and Variational Autoencoders (VAEs). GANs consist of two neural networks—a generator that creates data and a discriminator that evaluates its authenticity. This adversarial training process enhances the generator's ability to produce realistic content. VAEs operate by encoding input data into a latent space and then decoding it to generate new data, facilitating controlled and diverse content creation.

As used herein, it should be further appreciated large language models (LLMs), such as AI tool 132, are a specific application of generative AI focused on processing and generating human language text. For instance, LLMs may employ transformer architectures, which excel at handling long-range dependencies in text through a mechanism known as self-attention. This mechanism allows LLMs to process and generate text with high levels of contextual understanding and coherence. A prominent example of LLMs is the Generative Pre-trained Transformer (GPT) series. These models undergo extensive pre-training on large, diverse text corpora to learn language patterns, followed by fine-tuning on specific tasks to optimize performance.

LLMs are capable of performing a wide range of language-related tasks, including text completion, translation, summarization, and conversational response generation. Accordingly, it should be appreciated that AI tool 132 may be configured to generate coherent and contextually relevant text to facilitate any of various natural language processing (NLP) applications including, but not limited to, generating human-like responses to communicate via chatbots, avatars, etc., as contemplated herein.

### Exemplary Implementations

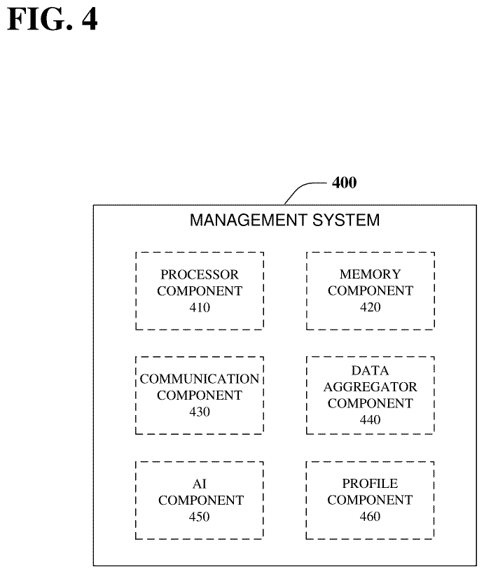

Referring next to FIG. 4, a block diagram of an exemplary management system is provided, wherein it is contemplated that management system 400 is substantially similar to management system 130. As illustrated, management system 400 may include a processor component 410, a memory component 420, a communication component 430, a data aggregator component 440, an AI component 450 (e.g., substantially similar to AI tool 132), and a profile component 460. Components 410-460 may reside together in a single location or separately in different locations in various combinations, including, for example, a configuration in which at least one of the aforementioned components reside in a cloud.

In one aspect, processor component 410 is configured to execute computer-readable instructions related to performing any of a plurality of functions. Processor component 410 can be a single processor or a plurality of processors which analyze and/or generate information utilized by memory component 420, communication component 430, data aggregator component 440, AI component 450, and/or profile component 460. Additionally or alternatively, processor component 410 may be configured to control one or more components of management system 400.

In another aspect, memory component 420 is coupled to processor component 410 and configured to store computer-readable instructions executed by processor component 410. Memory component 420 may also be configured to store any of a plurality of other types of data including data generated by any of communication component 430, data aggregator component 440, AI component 450, and/or profile component 460. Memory component 420 may be configured to store any of several types of information explained above, including the contents of profile database 134, for example.

Memory component 420 can be configured in a number of different configurations, including as random access memory, battery-backed memory, Solid State memory, hard disk, magnetic tape, etc. Various features can also be implemented upon memory component 420, such as compression and automatic back up (e.g., use of a Redundant Array of Independent Drives configuration). In one aspect, the memory may be located on a network, such as a “cloud storage” solution.

Communication component 430 may be configured to interface management system 400 with external entities. For example, communication component 430 may be configured to receive and/or transmit data via a wireless and/or wired network. In a particular embodiment, communication component 430 may be configured to interface with software applications via an application program interface (e.g., to facilitate interfacing management system 130 with software application 152 via API 136, as shown in FIG. 3).

Data aggregator component 440 may be coupled to communication component 430 and configured to aggregate data associated with a user (e.g., a person or entity) from any of a plurality of data sources (e.g., data sources 140). AI tool 450 may then be configured to interpret the aggregated data and infer at least one attribute associated with the user, whereas profile component 460 may be configured to create a digital profile of the user based on the interpretation of the data, wherein the digital profile includes the at least one attribute associated with the user that was inferred by AI tool 450.

Various other aspects of management system 400 are also contemplated. For instance, it is contemplated that management system 400 may be configured to generate digital profiles based on data collected from various data sources. In a particular aspect, the aggregated data includes data collected from a first data source and data collected from second data source, wherein the first data source is different than the second data source. Examples of such data sources include, but are not limited to, social media sources (e.g., Facebook®, LinkedIn®, etc.), financial institution sources (e.g., banks), multimedia storage sources (e.g., Google Photos®, Dropbox®, etc.), retail sources (e.g., Amazon®), entertainment/streaming sources (e.g., Netflix®, Spotify®, etc.), and/or location-related sources (e.g., Google Maps®, highway/bridge tolls, etc.).

In another aspect disclosed herein, it is contemplated that management system 400 is configured to generate digital profiles based on disparate types of data collected from a single data source. For instance, the single data source may be a social media account, wherein a first type of data is data in the social media account provided by a first user and a second type of data is data in the social media account provided by a second user (e.g., where a first user posts on social media about dogs, and a second user comments on that post that the first user is a great dog sitter, wherein management system 400 infers that the first user “values” dogs, pets, animals, etc.). In another example, a first type of data is profile data associated with a profile section of the social media account and a second type of data is content included in a social media post associated with the social media account (e.g., where a user's profile data includes work history as attorney, and the user posts on social media about presenting at a conference about immigration law, wherein management system 400 infers that the user is “skilled” in immigration law). In yet another example, a first type of data is a multimedia file uploaded onto the social media account (e.g., a photo, video, etc.) and a second type of data is content included in a social media post associated with the social media account (e.g., where the user's profile photo is the logo of a particular baseball team, and the user posts on social media about baseball, wherein management system 400 infers that the user has an “interest” in baseball).

Management system 400 may also be configured to categorize attributes inferred by AI component 450. For instance, management system 400 may be configured to categorize a plurality of attributes into a plurality of categories (e.g., categorizing an inference that a user likes to hike as an “interest”, categorizing an inference that a user values diversity as a “value”; categorizing an inference that a user is a lawyer as a “skill”; and categorizing an inference that a user is smart as a “trait”). Within such embodiment, management system 400 may be further configured to identify a subset of the plurality of categories, wherein profile component 460 is configured to create digital profiles that include digital sub-profiles based on the subset (e.g., where a user only wants to know about another user's “values”).

Management system 400 may also be configured to prioritize the plurality of categories based on a criteria, wherein profile component 460 is configured to create a prioritized digital profile based on the criteria. For example, within a matchmaking context where a user criteria is “date quality”, profile component 460 may be configured to create a digital profile that prioritizes “values” and “interests”. Within such embodiment, it is contemplated that a matchmaking software application (e.g., software application 152) may leverage management system 400 to match a first user with a second user based on an alignment of inferred attributes of the first user with corresponding inferred attributes of the second user (e.g., where both the first and second users “value” a particular religion). In another aspect, it is contemplated that management system 400 may be configured to facilitate matching a first user with a second user based on a search criteria provided by either user (e.g., where a user is a consumer searching for retail users that “value” diversity).

In yet another aspect, it is contemplated that management system may be configured to aid users after a match with another user has been made. For instance, within the context of a networking event where a user wants to connect with people matching a particular profile (e.g., a startup founder wanting to connect with capital providers), the user may not know how to begin a conversation once a match has been identified. To aid in such circumstances, management system 400 may be configured to generate speaking prompts based on an alignment of attributes of the user and the person the user is matched with. Alternatively, it is contemplated that such prompts may be generated based on a search criteria provided by the user.

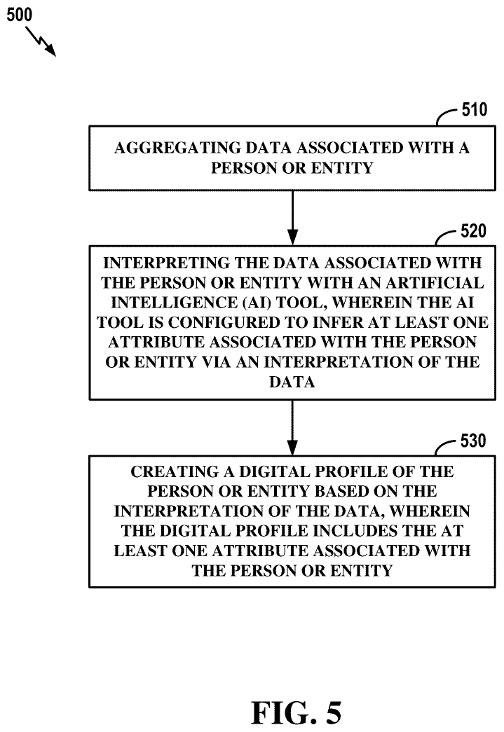

Referring next to FIG. 5, a flow diagram is provided of an exemplary profile generation methodology according to an embodiment. As illustrated, process 500 includes a series of acts that may be performed by a management system (e.g., management system 130 or 400) according to an aspect of the subject specification, wherein the series of acts may include any of the plurality of acts described with respect to management system 130 or 400. For instance, process 500 may be implemented by employing a processor to execute computer executable instructions stored on a computer readable storage medium to implement the series of acts. In another embodiment, a computer-readable storage medium comprising code for causing at least one computer to implement the acts of process 500 is contemplated.

As illustrated, process 500 may begin at act 510 with management system 130 or 400 aggregating data associated with a person or entity. At act 520, process 500 then proceeds with management system 130 or 400 interpreting the data associated with the person or entity with an AI tool, wherein the AI tool is configured to infer at least one attribute associated with the person or entity via an interpretation of the data. Process 500 then concludes at act 530 with management system 130 or 400 creating a digital profile of the person or entity based on the interpretation of the data, wherein the digital profile includes the at least one attribute associated with the person or entity.

### Terminology

For purposes of the present disclosure, the following terms shall have the meanings set forth below. These definitions are intended to be illustrative rather than limiting, and it should be appreciated that each term may encompass additional variations and embodiments as supported by the disclosure.

As used herein, the term “context” refers to the circumstances, environment, or conditions associated with a person or entity at a given point in time, which may influence the generation of a digital profile, a recommendation, or a connection prompt. A context may be physical (e.g., may include a user's presence at a specific location, such as a coffee shop, professional conference, or concert venue), digital (e.g., may include a user's participation in an online chatroom, video call, or social media interaction), social (e.g., may include a user attending a wedding, networking reception, or social gathering), and/or professional (e.g., may include a user engaging in a business meeting, trade show, or recruiting fair). It should be appreciated that a context may be hybrid in nature, and may be represented hierarchically or as a set of nested sub-contexts. Namely, it should be appreciated that a context may be “nested” (e.g., a user in a work context, within which they are at a professional conference, within which they are attending a breakout session, within which they are in a one-on-one meeting) or “combinatorial” (e.g., a user simultaneously seeking investors, navigating a city safely, and socializing with colleagues while attending a conference). Also, in certain embodiments, it should be appreciated that a context operates as a branching structure, such that broad life facets (e.g., “work,” “family”) branch into narrower sub-contexts that may be dynamically combined.

As used herein, the term “inferred desired outcome” refers to a predicted or deduced goal, preference, or intended result associated with a person or entity, as determined by an artificial intelligence (AI) tool through interpretation of attributes and contextual signals. An inferred desired outcome may be based on explicitly provided user goals, implicit behavioral patterns, or comparisons with other users exhibiting similar attributes, and may evolve dynamically as additional data is collected. For example, A user may explicitly indicate a goal such as “meet investors,” whereas the system may infer the same outcome based on observed context and prior data even absent an explicit statement. Also, in certain cases, the outcome may extend beyond person-to-person connections to include non-human outcomes, such as matching the user with the safest route home, recommending a restaurant aligned with user values (e.g., family-owned, minority-owned), or suggesting a stress-relieving activity such as a nearby park visit. In another embodiment, outcomes may be inferred by aggregating patterns observed across multiple users with similar digital profiles. In yet another embodiment, outcomes may be refined adaptively, wherein the system adjusts its inference in response to user acceptance or rejection of prior suggestions. Accordingly, inferred desired outcomes broaden the system's functionality from conventional matching to general-purpose goal alignment and personal assistance.

As used herein, the term “suggestion” refers to a system-generated recommendation, prompt, or guidance provided to a person or entity in light of at least one attribute, an inferred desired outcome, and an associated context. A suggestion may be proactive or reactive, explanatory or directive, and may be delivered via text, voice, graphical display, or other digital or in-person outputs. For example, in one embodiment, a suggestion comprises a connection suggestion, such as recommending that a user meet another individual at a conference due to aligned professional interests. In another embodiment, a suggestion comprises a navigation suggestion, such as advising a user to take a safer route when leaving an event. In yet another embodiment, a suggestion comprises a wellness suggestion, such as encouraging a user to take a short break in a nearby park when stress indicators are detected. In still another embodiment, a suggestion comprises a commercial suggestion, such as recommending a restaurant, vendor, or service provider consistent with the user's preferences or values. Suggestions may also be explanatory, providing not only the recommendation but also the rationale (e.g., “connect with this individual because you both have experience in early-stage venture funding”). Accordingly, suggestions differ from conventional recommendations by being contextualized, explainable, and purpose-driven, thereby aligning with the inferred desired outcomes of the user.

### Exemplary Networked and Distributed Environments

One of ordinary skill in the art can appreciate that various embodiments for implementing the use of a computing device and related embodiments described herein can be implemented in connection with any computer or other client or server device, which can be deployed as part of a computer network or in a distributed computing environment, and can be connected to any kind of data store. Moreover, one of ordinary skill in the art will appreciate that such embodiments can be implemented in any computer system or environment having any number of memory or storage units, and any number of applications and processes occurring across any number of storage units. This includes, but is not limited to, an environment with server computers and client computers deployed in a network environment or a distributed computing environment, having remote or local storage.

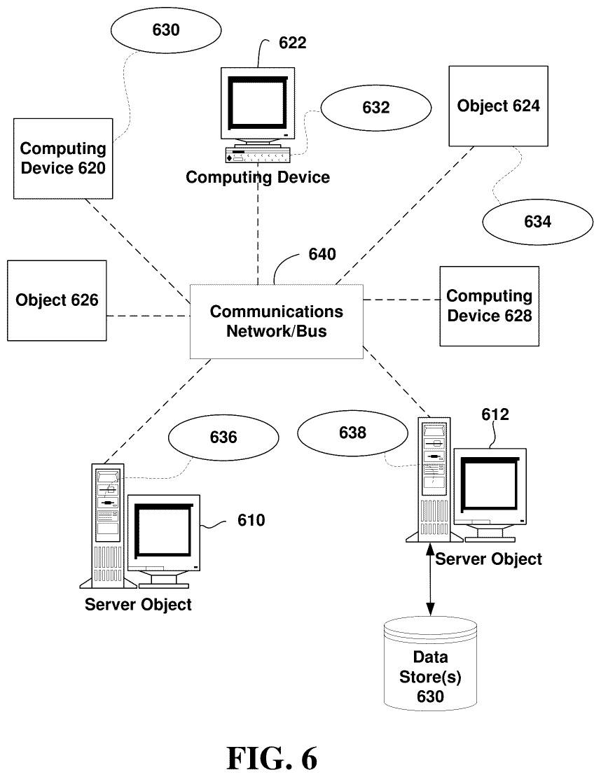

FIG. 6 provides a non-limiting schematic diagram of an exemplary networked or distributed computing environment. The distributed computing environment comprises computing objects or devices 610, 612, etc. and computing objects or devices 620, 622, 624, 626, 628, etc., which may include programs, methods, data stores, programmable logic, etc., as represented by applications 630, 632, 634, 636, 638. It can be appreciated that computing objects or devices 610, 612, etc. and computing objects or devices 620, 622, 624, 626, 628, etc. may comprise different devices, such as PDAs (personal digital assistants), audio/video devices, mobile phones, MP3 players, laptops, etc.

Each computing object or device 610, 612, etc. and computing objects or devices 620, 622, 624, 626, 628, etc. can communicate with one or more other computing objects or devices 610, 612, etc. and computing objects or devices 620, 622, 624, 626, 628, etc. by way of the communications network 640, either directly or indirectly. Even though illustrated as a single element in FIG. 6, network 640 may comprise other computing objects and computing devices that provide services to the system of FIG. 6, and/or may represent multiple interconnected networks, which are not shown. Each computing object or device 610, 612, etc. or 620, 622, 624, 626, 628, etc. can also contain an application, such as applications 630, 632, 634, 636, 638, that might make use of an API (application programming interface), or other object, software, firmware and/or hardware, suitable for communication with or implementation of the disclosed aspects in accordance with various embodiments.

There are a variety of systems, components, and network configurations that support distributed computing environments. For example, computing systems can be connected together by wired or wireless systems, by local networks or widely distributed networks. Currently, many networks are coupled to the Internet, which provides an infrastructure for widely distributed computing and encompasses many different networks, though any network infrastructure can be used for exemplary communications made incident to the techniques as described in various embodiments.

Thus, a host of network topologies and network infrastructures, such as client/server, peer-to-peer, or hybrid architectures, can be utilized. In a client/server architecture, particularly a networked system, a client is usually a computer that accesses shared network resources provided by another computer, e.g., a server. In the illustration of FIG. 6, as a non-limiting example, computing objects or devices 620, 622, 624, 626, 628, etc. can be thought of as clients and computing objects or devices 610, 612, etc. can be thought of as servers where computing objects or devices 610, 612, etc. provide data services, such as receiving data from computing objects or devices 620, 622, 624, 626, 628, etc., storing of data, processing of data, transmitting data to computing objects or devices 620, 622, 624, 626, 628, etc., although any computer can be considered a client, a server, or both, depending on the circumstances. Any of these computing devices may be processing data, or requesting services or tasks that may implicate aspects and related techniques as described herein for one or more embodiments.

A server is typically a remote computer system accessible over a remote or local network, such as the Internet or wireless network infrastructures. The client process may be active in a first computer system, and the server process may be active in a second computer system, communicating with one another over a communications medium, thus providing distributed functionality and allowing multiple clients to take advantage of the information-gathering capabilities of the server. Any software objects utilized pursuant to the user profiling can be provided standalone, or distributed across multiple computing devices or objects.

In a network environment in which the communications network/bus 640 is the Internet, for example, the computing objects or devices 610, 612, etc. can be Web servers with which the computing objects or devices 620, 622, 624, 626, 628, etc. communicate via any of a number of known protocols, such as HTTP. As mentioned, computing objects or devices 610, 612, etc. may also serve as computing objects or devices 620, 622, 624, 626, 628, etc., or vice versa, as may be characteristic of a distributed computing environment.

### Exemplary Computing Device

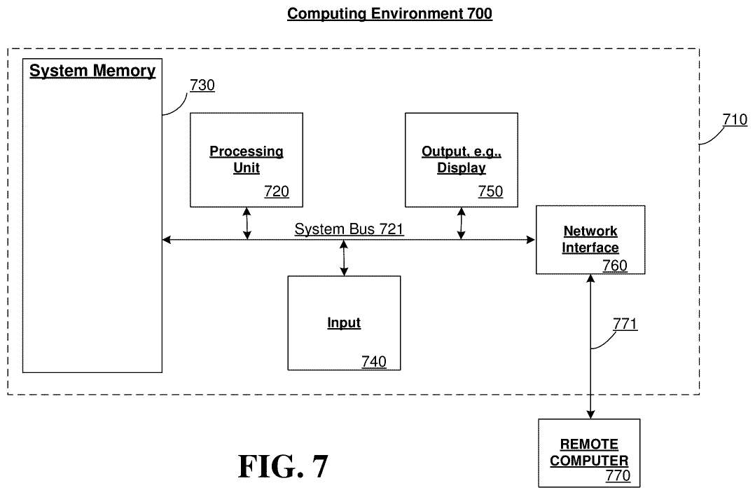

As mentioned, several of the aforementioned embodiments apply to any device wherein it may be desirable to include a computing device to facilitate implementing the aspects disclosed herein. It is understood, therefore, that handheld, portable and other computing devices and computing objects of all kinds are contemplated for use in connection with the various embodiments described herein. Accordingly, the below general purpose remote computer described below in FIG. 7 is but one example, and the embodiments of the subject disclosure may be implemented with any client having network/bus interoperability and interaction.

Although not required, any of the embodiments can partly be implemented via an operating system, for use by a developer of services for a device or object, and/or included within application software that operates in connection with the operable component(s).

Software may be described in the general context of computer executable instructions, such as program modules, being executed by one or more computers, such as client workstations, servers or other devices. Those skilled in the art will appreciate that network interactions may be practiced with a variety of computer system configurations and protocols.

FIG. 7 thus illustrates an example of a suitable computing system environment 700 in which one or more of the embodiments may be implemented, although as made clear above, the computing system environment 700 is only one example of a suitable computing environment and is not intended to suggest any limitation as to the scope of use or functionality of any of the embodiments. The computing environment 700 is not to be interpreted as having any dependency or requirement relating to any one or combination of components illustrated in the exemplary operating environment 700.

With reference to FIG. 7, an exemplary remote device for implementing one or more embodiments herein can include a general purpose computing device in the form of a handheld computer 710. Components of handheld computer 710 may include, but are not limited to, a processing unit 720, a system memory 730, and a system bus 721 that couples various system components including the system memory to the processing unit 720.

Computer 710 typically includes a variety of computer readable media and can be any available media that can be accessed by computer 710. The system memory 730 may include computer storage media in the form of volatile and/or nonvolatile memory such as read only memory (ROM) and/or random access memory (RAM). By way of example, and not limitation, memory 730 may also include an operating system, application programs, other program modules, and program data.

A user may enter commands and information into the computer 710 through input devices 740 A monitor or other type of display device is also connected to the system bus 721 via an interface, such as output interface 750. In addition to a monitor, computers may also include other peripheral output devices such as speakers and a printer, which may be connected through output interface 750.

The computer 710 may operate in a networked or distributed environment using logical connections to one or more other remote computers, such as remote computer 770. The remote computer 770 may be a personal computer, a server, a router, a network PC, a peer device or other common network node, or any other remote media consumption or transmission device, and may include any or all of the elements described above relative to the computer 710. The logical connections depicted in FIG. 7 include a network 771, such local area network (LAN) or a wide area network (WAN), but may also include other networks/buses. Such networking environments are commonplace in homes, offices, enterprise-wide computer networks, intranets and the Internet.

As mentioned above, while exemplary embodiments have been described in connection with various computing devices, networks and advertising architectures, the underlying concepts may be applied to any network system and any computing device or system in which it is desirable to implement the aspects disclosed herein.

There are multiple ways of implementing one or more of the embodiments described herein, e.g., an appropriate API, tool kit, driver code, operating system, control, standalone or downloadable software object, etc. which enables applications to implement the aspects disclosed herein. Embodiments may be contemplated from the standpoint of an API (or other software object), as well as from a software or hardware object that facilitates implementing the aspects disclosed herein in accordance with one or more of the described embodiments. Various implementations and embodiments described herein may have aspects that are wholly in hardware, partly in hardware and partly in software, as well as in software.

The word “exemplary” is used herein to mean serving as an example, instance, or illustration. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, for the avoidance of doubt, such terms are intended to be inclusive in a manner similar to the term “comprising” as an open transition word without precluding any additional or other elements.

As mentioned, the various techniques described herein may be implemented in connection with hardware or software or, where appropriate, with a combination of both. As used herein, the terms “component,” “system” and the like are likewise intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it is noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

In view of the exemplary systems described supra, methodologies that may be implemented in accordance with the disclosed subject matter can be appreciated with reference to the flowcharts of the various figures. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Where non-sequential, or branched, flow is illustrated via flowchart, it can be appreciated that various other branches, flow paths, and orders of the blocks, may be implemented which achieve the same or a similar result. Moreover, not all illustrated blocks may be required to implement the methodologies described hereinafter.

While in some embodiments, a client side perspective is illustrated, it is to be understood for the avoidance of doubt that a corresponding server perspective exists, or vice versa. Similarly, where a method is practiced, a corresponding device can be provided having storage and at least one processor configured to practice that method via one or more components.

While the various embodiments have been described in connection with the preferred embodiments of the various figures, it is to be understood that other similar embodiments may be used or modifications and additions may be made to the described embodiment for performing the same function without deviating there from. Still further, one or more aspects of the above described embodiments may be implemented in or across a plurality of processing chips or devices, and storage may similarly be affected across a plurality of devices. Therefore, the present invention should not be limited to any single embodiment.

What is claimed is:

1. A method, comprising:
employing a processor to execute computer executable instructions stored on a computer readable storage medium to implement the following acts:
aggregating data associated with a person or entity;
interpreting the data associated with the person or entity with an artificial intelligence (AI) tool, wherein the AI tool is configured to infer at least one attribute associated with the person or entity via an interpretation of the data; and
creating a digital profile of the person or entity based on the interpretation of the data, wherein the digital profile includes the at least one attribute associated with the person or entity.

2. The method of claim 1, wherein the data includes data collected from a first data source and data collected from second data source, and wherein the first data source is different than the second data source.

3. The method of claim 2, wherein the first data source is a social media source and the second data source is a non-social media source.

4. The method of claim 2, wherein the first data source is a financial institution source and the second data source is a non-financial institution source.

5. The method of claim 2, wherein the first data source is a multimedia storage source and the second data source is a non-multimedia storage source.

6. The method of claim 1, wherein the data includes disparate types of data collected from a single data source.

7. The method of claim 6, wherein the single data source is a social media account, and wherein a first type of data is data in the social media account provided by a first user and a second type of data is data in the social media account provided by a second user.

8. The method of claim 6, wherein the single data source is a social media account, and wherein a first type of data is profile data associated with a profile section of the social media account and a second type of data is content included in a social media post associated with the social media account.

9. The method of claim 6, wherein the single data source is a social media account, and wherein a first type of data is a multimedia file uploaded onto the social media account and a second type of data is content included in a social media post associated with the social media account.

10. A method, comprising:
employing a processor to execute computer executable instructions stored on a computer readable storage medium to implement the following acts:
aggregating data associated with a person or entity, wherein the data includes a plurality of individual aspects associated with the person or entity;
interpreting the data associated with the person or entity with an artificial intelligence (AI) tool, wherein the AI tool is configured to infer at least one attribute associated with the person or entity via an interpretation of at least one of the plurality of individual aspects associated with the person or entity; and
categorizing the at least one attribute into at least one category.

11. The method of claim 10, wherein the AI tool is configured to infer a plurality of attributes associated with the person or entity via an interpretation of a single one of the plurality of individual aspects associated with the person or entity.

12. The method of claim 11, further comprising categorizing a first of the plurality of attributes into a first category and categorizing a second of the plurality of attributes into a second category.

13. The method of claim 10, wherein the AI tool is configured to infer the at least one attribute associated with the person or entity via a combined interpretation of at least two of the plurality of individual aspects associated with the person or entity.

14. The method of claim 13, wherein a first of the at least two of the plurality of individual aspects associated with the person or entity is from data collected from a first data source and a second of the at least two of the plurality of individual aspects associated with the person or entity is from data collected from a second data source different than the first data source, and wherein the combined interpretation is an inference based on a combination of the first of the at least two of the plurality of individual aspects associated with the person or entity and the second of the at least two of the plurality of individual aspects associated with the person or entity.

15. A method, comprising:
employing a processor to execute computer executable instructions stored on a computer readable storage medium to implement the following acts:
aggregating data associated with a person or entity, wherein the data includes a plurality of individual aspects associated with the person or entity;
interpreting the data associated with the person or entity with an artificial intelligence (AI) tool, wherein the AI tool is configured to infer at least one attribute associated with the person or entity via an interpretation of at least one of the plurality of individual aspects associated with the person or entity; and
providing a suggestion to the person or entity in accordance with an inferred desired outcome, wherein the inferred desired outcome is an inference based on the at least one attribute associated with the person or entity within a context associated with the person or entity.

16. The method of claim 15, wherein the context associated with the person or entity is at least one of a physical context, digital context, social context, or professional context.

17. The method of claim 15, further comprising matching the person or entity with a second person or entity based on the context associated with the person or entity and an alignment of the at least one attribute associated with the person or entity with a corresponding attribute associated with the second person or entity, wherein the suggestion is a suggestion that the person or entity connect with the second person or entity to facilitate the inferred desired outcome.

18. The method of claim 17, further comprising generating at least one connection prompt to facilitate connecting the person or entity with the second person or entity in accordance with the inferred desired outcome.

19. The method of claim 17, wherein the context is a digital context, and wherein the at least one connection prompt facilitates connecting the person or entity with the second person or entity via a digital medium.

20. The method of claim 17, wherein the context is an in-person context, and wherein the at least one connection prompt facilitates connecting the person or entity with the second person or entity in-person.
